(19) United States
(12) Patent Application Publication
(10) Pub. No.: US 2026/0341612 A1
(43) Pub. Date: Oct. 29, 2026

(54) SWITCH WITH RESTART PROTECTION FUNCTION FOR TRIGGER

(71) Applicant: Zhejiang Jiaben Electronics Co., Ltd., Wenzhou City (CN)

(72) Inventors: Shenglong Ni, Wenzhou City (CN); Shoufu Zhu, Wenzhou City (CN); Shanbin Lei, Wenzhou City (CN)

(21) Appl. No.: 19/659,061

(22) Filed: Apr. 27, 2026

(30) Foreign Application Priority Data
Apr. 28, 2025 (CN) 202510541012.3

(51) Int. Cl. H01H 21/22; H01H 9/20; H01H 21/12

(52) U.S. Cl. CPC H01H 21/22; H01H 9/20; H01H 21/12

(57) ABSTRACT

Provided is a switch with a restart protection function for a trigger. The switch includes a base body, an upper cover, a push shaft, a reset spring and a circuit board assembly. One end of the push shaft extends out of a box body composed of the base body and the upper cover, and a trigger is arranged at one end of the push shaft extending out of the box body. A locking structure is arranged on the trigger. A locking block structure cooperating with the locking structure is arranged on the upper cover, and an electrical connection structure cooperating with the circuit board assembly is arranged in the box body. According to the switch, the circuit board assembly is arranged in the switch, and a control board of the switch is integrated on the circuit board assembly.

### CROSS-REFERENCE TO RELATED APPLICATION

This patent application claims the benefit and priority of Chinese Patent Application No. 2025105410123, entitled "SWITCH WITH RESTART PROTECTION FUNCTION FOR TRIGGER" filed on Apr. 28, 2025, the disclosure of which is incorporated by reference herein in its entirety as part of the present application.

### TECHNICAL FIELD

The present disclosure relates to a switch for a trigger, and particularly relates to a switch with a restart protection function for a trigger.

### BACKGROUND

Currently, switches for medium-sized angle grinders on the market basically have similar functions, but they have the following function shortcomings.
1. The commonly used switches of the medium-sized angle grinders are typically mechanical switches, which achieve a closing and locking function through a locking button. After the switch is locked, if the medium-sized angle grinder experiences an unexpected power outage, and then the power is restored, the medium-sized angle grinder will immediately start. This does not conform to the GB15093.1 standard and poses significant safety hazards.
2. The commonly used switches of the commonly used medium-sized angle grinders are mechanical switches, which lack a soft-start function. When the switch is started, the switch of the medium-sized angle grinder may vibrate due to inertia. Dropping easily occurs in case of unstable gripping. This also poses significant safety hazards.
3. Some of the commonly used switches of the medium-sized angle grinders are formed by combining mechanical switches with controllers. In this way, there are more connected lines, and the assembling process is complicated. This brings difficulties in the production of the medium-sized angle grinders.

Therefore, it is necessary to design a switch with a restart protection function for a trigger.

### SUMMARY

A first aspect according to an embodiment of the present disclosure provides a switch with a restart protection function for a trigger. The switch includes a base body, an upper cover, a push shaft, a reset spring and a circuit board assembly. One end of the push shaft extends out of a box body composed of the base body and the upper cover. The trigger is arranged at one end of the push shaft extending out of the box body.

A locking structure is arranged on the trigger. A locking block structure cooperating with the locking structure is arranged on the upper cover. An electrical connection structure cooperating with the circuit board assembly is arranged in the box body.

In one embodiment, the locking structure includes a locking button and a locking button spring. A mounting cavity is formed in the locking button. Mounting posts are respectively arranged at a bottom and a top of the mounting cavity. The locking button spring is mounted within the mounting cavity through the mounting posts.

A mounting hole is formed in the trigger. First through holes are respectively formed in two side walls of the mounting hole; second through holes are respectively formed in two side walls of the mounting cavity. A first fastener passes through the first through holes and the second through holes to movably connect the locking button with the trigger.

The locking block structure includes a locking button pressing block and a locking button latch hook. Both the locking button pressing block and the locking button latch hook cooperate with the locking button.

In one embodiment, the electrical connection structure includes a movable contact terminal assembly, a stationary contact piece assembly cooperating with the movable contact terminal assembly, a movable contact terminal bracket for fixing the movable contact terminal assembly and a contact spring group for electrically connecting the movable contact terminal bracket with the circuit board assembly. The stationary contact piece assembly, the movable contact terminal bracket and the contact spring group are mounted on the base body.

The electrical connection structure further includes a connection sheet and an output sheet that are arranged on the base body.

The connection sheet is provided with a connection sheet connection column. The connection sheet is electrically connected with the circuit board assembly through the connection sheet connection column. The output sheet is provided with an output sheet connection column. The output sheet is electrically connected with the circuit board assembly through the output sheet connection column.

In one embodiment, the movable contact terminal assembly includes a rotating block, a driving spring plate, a movable contact terminal and a movable contact point.

A push shaft groove is formed in one end of the push shaft arranged in the box body. A rotating block connection head is arranged at one end of the rotating block. The one end of the rotating block is connected with the push shaft through cooperation between the rotating block connection head and the push shaft groove.

A rotating block hook is arranged at another end of the rotating block. A first clamping slot for spring plate is formed in one end of the driving spring plate. The one end of the driving spring plate is connected with the rotating block through cooperation between the rotating block hook and the first clamping slot for spring plate.

A second clamping slot for spring plate is formed in another end of the driving spring plate. A movable contact terminal connection head is arranged at one end of the movable contact terminal. The other end of the driving spring plate is connected with the movable contact terminal through cooperation between the second clamping slot for spring plate and the movable contact terminal connection head.

A movable contact terminal connection block is arranged at another end of the movable contact terminal. A movable contact terminal connection slot is formed in the movable contact terminal connection block. The movable contact terminal bracket is provided with a bracket connection head. A bracket connection hole is formed in the bracket connection head. The movable contact terminal connection block is connected with a bottom of the rotating block through the movable contact terminal connection slot after passing through the bracket connection hole.

The movable contact point is arranged at a bottom of one end, connected with the driving spring plate, of the movable contact terminal.

In one embodiment, the stationary contact piece assembly includes a first binding post, a second binding post, a stationary contact piece and a stationary contact point. The first binding post is connected with the connection sheet. The second binding post is connected with the stationary contact piece. The stationary contact point is arranged on the stationary contact piece and cooperates with the movable contact point.

In one embodiment, the stationary contact piece assembly further includes a screw fixing plate. Both the first binding post and the second binding post are fixed to the base body through the screw fixing plate.

In one embodiment, the movable contact terminal assembly further includes an auxiliary spring plate. The auxiliary spring plate is provided with a spring plate mounting hole group. The movable contact terminal bracket is provided with a bracket mounting hole group. A second fastener sequentially passes through the bracket mounting hole group and the spring plate mounting hole group to connect the auxiliary spring plate with the movable contact terminal bracket.

In one embodiment, the base body is provided with a base body mounting slot group. The first binding post and the second binding post are arranged within the base body mounting slot group.

Binding post mounting heads are respectively arranged at tops of both the first binding post and the second binding post. Wiring holes are respectively formed in the connection sheet and the stationary contact piece. The connection sheet and the stationary contact piece are respectively connected with the first binding post and the second binding post through cooperation between the binding post mounting heads and the wiring holes.

In one embodiment, a stepped sealing sleeve is arranged on a portion, extending out from the box body, of the push shaft. An upper cover mounting platform is arranged at a top of the upper cover. The stepped sealing sleeve is connected with the upper cover mounting platform.

A first peripheral groove for base body and a second peripheral groove for base body are formed in the base body. The upper cover is provided with a first peripheral protruding bar for upper cover and a second peripheral protruding bar for upper cover. The first peripheral groove for base body and the first peripheral protruding bar for upper cover form a first labyrinth interlocking structure. The second peripheral groove for base body and the second peripheral protruding bar for upper cover form a second labyrinth interlocking structure.

In one embodiment, an upper cover connection post is arranged at a top of the upper cover. A trigger connection post is arranged at a bottom of the trigger; one end of the reset spring is connected with the upper cover connection post. Another end of the reset spring is connected with the trigger connection post.

The embodiments of the present disclosure include the following technical effects.

According to the switch with the restart protection function for the trigger provided in the embodiments, the circuit board assembly is arranged in the switch, and a control board of the switch is integrated on the circuit board assembly, such that the switch in the embodiments can achieve power-off protection, overcurrent protection and soft start functions without additional wire connection. Furthermore, the switch for the trigger in the embodiments can achieve an instant switch-on function and an instant switch-off function, and can achieve a closing and locking function.

### BRIEF DESCRIPTION OF THE DRAWINGS

FIG. 1 is a three-dimensional diagram of a switch with a restart protection function for a trigger according to the present disclosure.

FIG. 2 is a three-dimensional diagram of a back view of the switch with the restart protection function for the trigger in FIG. 1.

FIG. 3 is a partially cross-sectional view of a contact point portion when the switch in FIG. 1 is in an off state.

FIG. 4 is a partially cross-sectional view of the contact point portion when the switch in FIG. 1 is in an on state.

FIG. 5 is a structural exploded view of the switch with the restart protection function for the trigger according to the present disclosure.

FIG. 6 is a schematic diagram of an electrical connection structure when the switch in FIG. 1 is in an off state.

FIG. 7 is a schematic diagram of the electrical connection structure when the switch in FIG. 1 is in an on state.

FIG. 8 is a schematic diagram of a base body of the switch with the restart protection function for the trigger according to the present disclosure.

FIG. 9 is a schematic diagram of assembling of the base body, the electrical connection structure and a push shaft of the switch with the restart protection function according to the present disclosure.

FIG. 10 is a schematic circuit diagram of the switch with the restart protection function according to the present disclosure.

FIG. 11 is an electronic circuit diagram of a circuit board of the switch with the restart protection function according to the present disclosure.

FIG. 12 is an electronic circuit diagram of the circuit board of the switch with the restart protection function according to the present disclosure.

List of the reference characters: 1 base body; 2 upper cover; 3 push shaft; 4 reset spring; 5 circuit board assembly; 6 trigger; 7 locking structure; 8 locking block structure; 9 electrical connection structure; 10 first fastener; 11 second fastener; 12 stepped sealing sleeve; 13 pin; 31 push shaft groove; 32 push shaft through hole; 61 mounting hole; 62 trigger fixing hole; 611 first through hole; 71 locking button; 72 locking button spring; 711 mounting cavity; 712 tail hook; 713 second through hole; 81 locking button pressing block; 82 locking button latch hook; 91 movable contact terminal assembly; 92 stationary contact piece assembly; 93 movable contact terminal bracket; 94 contact spring group; 95 connection sheet; 96 output sheet; 951 connection sheet connection post; 961 output sheet connection post; 911 rotating block; 912 driving spring plate; 913 movable contact terminal; 914 movable contact point; 915 auxiliary spring plate; 9111 rotating block connection head; 9112 rotating block hook; 9121 first clamping slot for spring plate; 9122 second clamping slot for spring plate; 9131 movable contact terminal connection head; 9132 movable contact terminal connection block; 9133 movable contact terminal connection slot; 931 bracket connection head; 932 bracket connection hole; 933 bracket mounting hole group; 921 first binding post; 922 second binding post; 923 stationary contact piece; 924 stationary contact point; 925 screw fixing plate; 926 binding post mounting head; 927 wiring hole; 9151 spring plate mounting hole group; 101 base body mounting slot group; 102 first peripheral groove for base body; 103 second peripheral groove for base body; 201 upper cover mounting platform; 202 upper cover connection post; 203 upper cover fixing platform; 204 fixing post; 301 switch; 302 power failure detection circuit; 303 micro control unit (MCU) power supply circuit; 304 MCU minimum system; 305 triggering circuit; 306 current detection circuit; 307 power transistor; and 308 load.

### DETAILED DESCRIPTION OF THE EMBODIMENTS

The following will provide a detailed description for the present disclosure in conjunction with the embodiments and the accompanying drawings. It should be noted that the described embodiments are merely intended to facilitate understanding of the present disclosure and do not impose any limitations on it. The terms of direction such as up, down, left, and right in the present disclosure are used for the convenience of describing the accompanying drawings and do not constitute a limitation on the scope of protection.

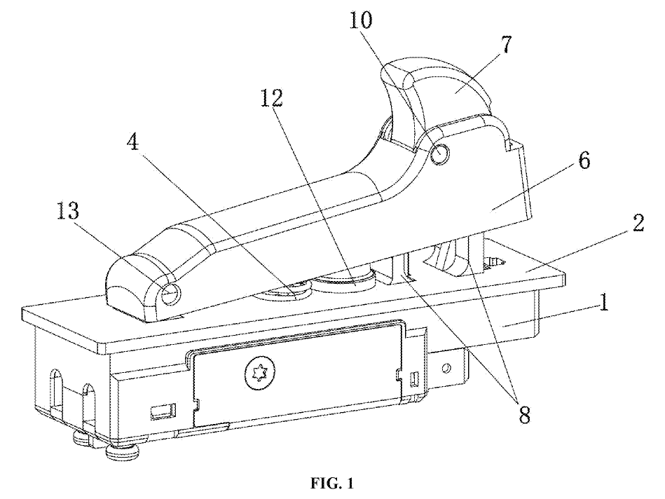

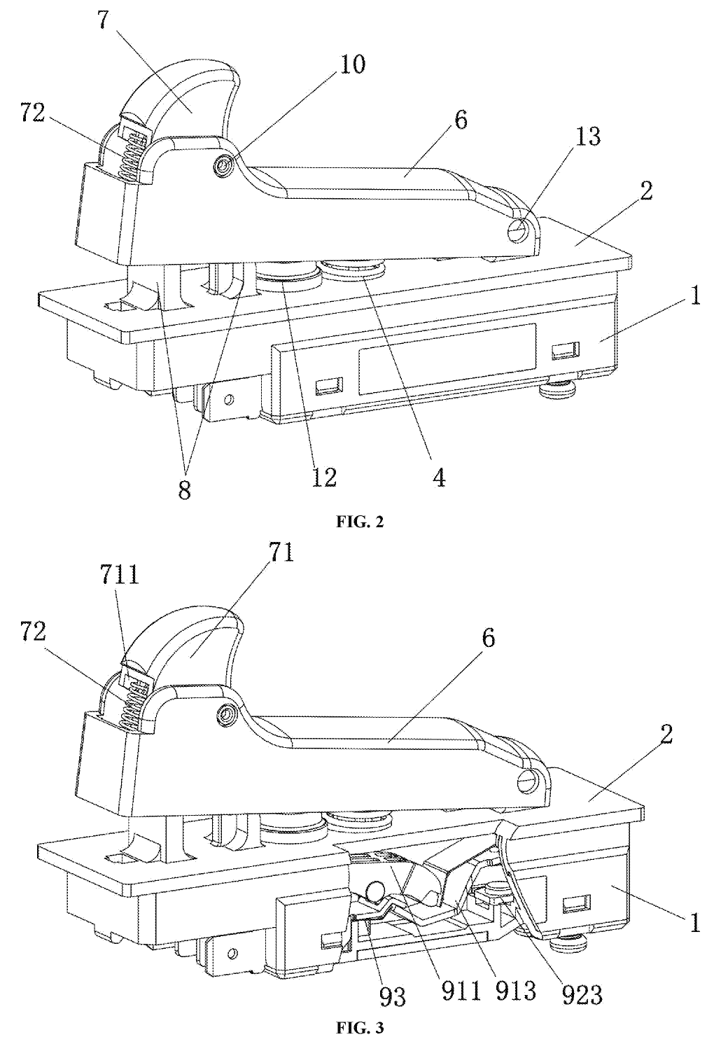

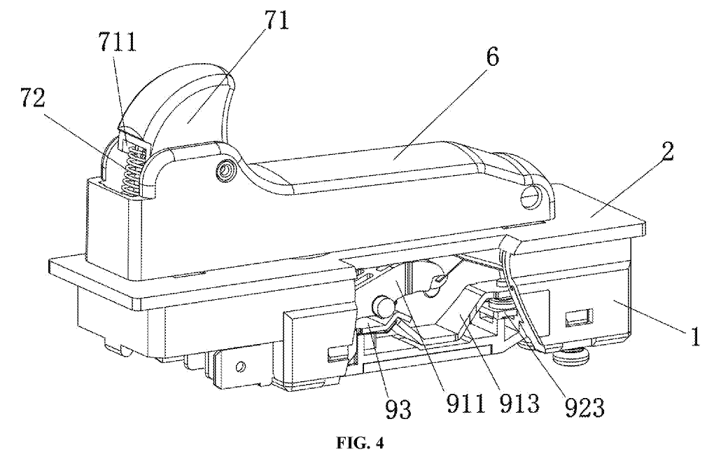

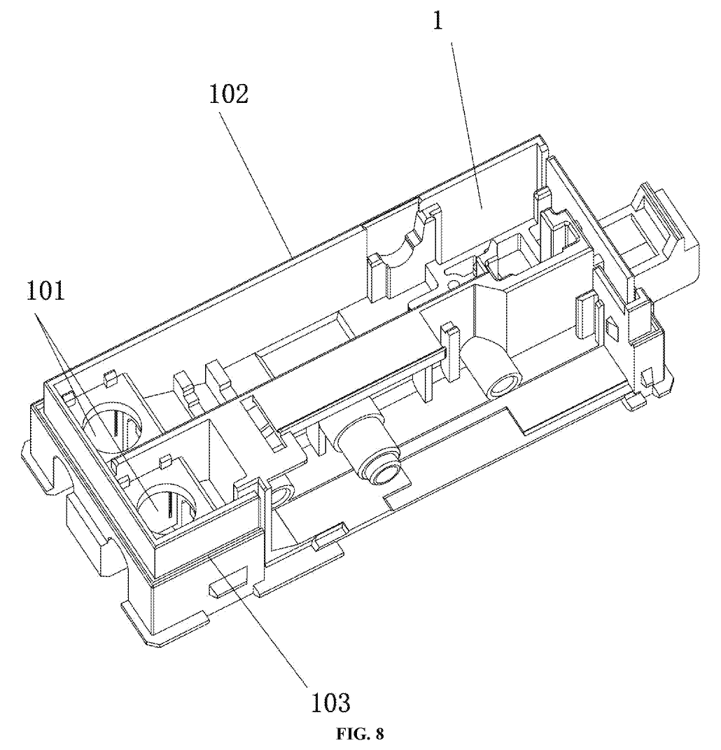

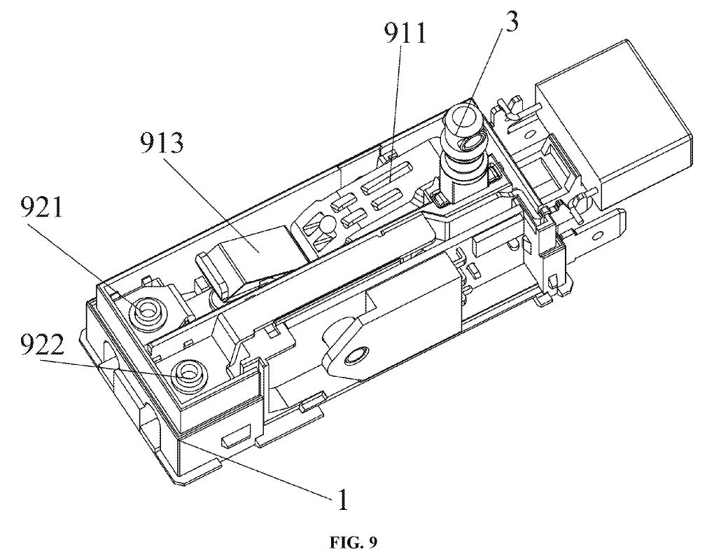

As shown in FIGS. 1-9, an embodiment of the present disclosure provides a switch with a restart protection function for a trigger, including a base body 1, an upper cover 2, a push shaft 3, a reset spring 4 and a circuit board assembly 5. One end of the push shaft 3 extends out of a box body composed of the base body 1 and the upper cover 2. A trigger 6 is arranged at the one end of the push shaft 3 extending out of the box body. A locking structure 7 is arranged on the trigger 6. A locking block structure 8 cooperating with the locking structure 7 is arranged on the upper cover 2. An electrical connection structure 9 cooperating with the circuit board assembly 5 is arranged in the box body.

According to the switch with the restart protection function for the trigger provided in the present disclosure, the circuit board assembly is arranged in the switch, and a control board of the switch is integrated on the circuit board assembly, such that the switch in the embodiment can achieve power-off protection, overcurrent protection and soft start functions without additional wire connection.

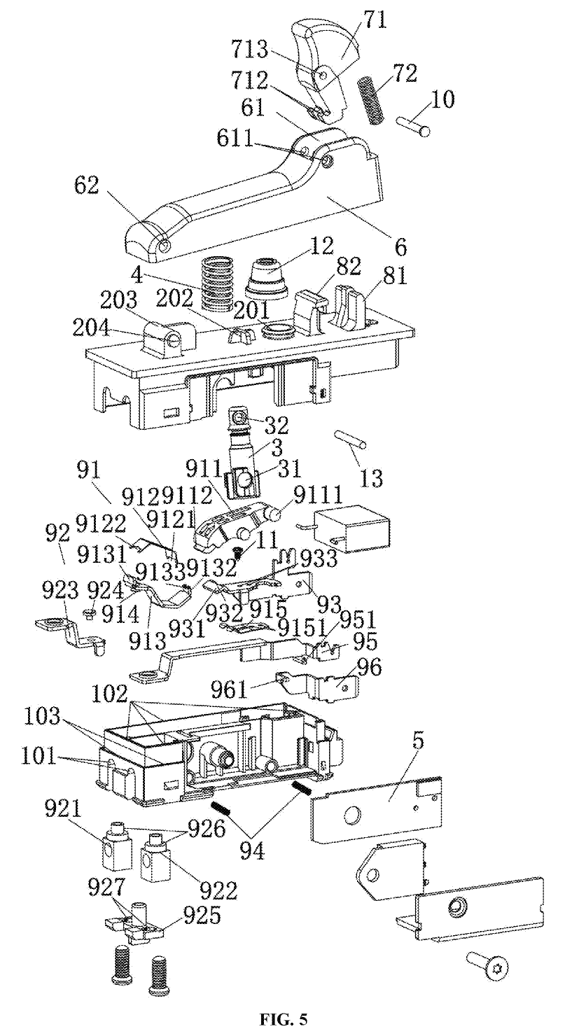

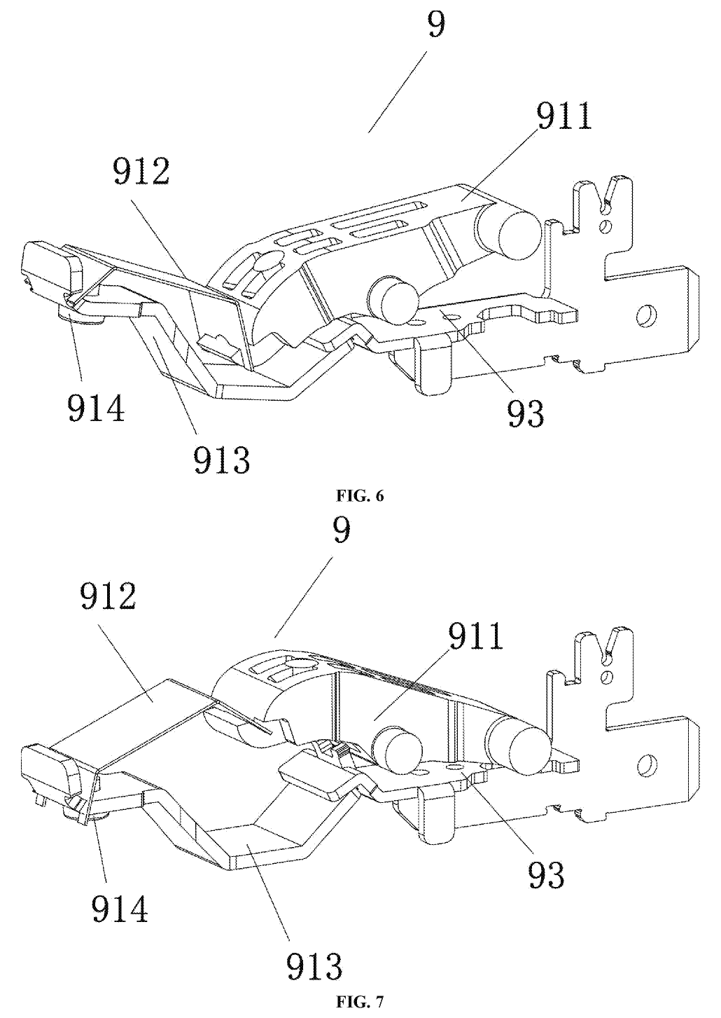

As shown in FIG. 5, the locking structure 7 includes a locking button 71 and a locking button spring 72. A mounting cavity 711 is formed in the locking button 71, and mounting posts are respectively arranged at a bottom and a top of the mounting cavity 711, such that the locking button spring 72 can be mounted within the mounting cavity 711 through the mounting posts at the bottom and the top of the mounting cavity 711. A mounting hole 61 is formed in the trigger 6, and first through holes 611 are formed in two side walls of the mounting hole 61. In addition, second through holes 713 are formed in two side walls of the mounting cavity 711, such that a first fastener 10 passes through the first through holes 611 and the second through holes 713 to movably connect the locking button 71 with the trigger 6. The locking block structure 8 is configured to include a locking button pressing block 81 and a locking button latch hook 82, such that both the locking button pressing block 81 and the locking button latch hook 82 cooperate with the locking button 71. It should be noted that the first fastener may be a rivet.

In this embodiment, a locking structure is arranged on the trigger, and a locking block structure is arranged on the upper cover. After the switch is electrically connected, the locking button 71 is first pulled, and then the trigger 6 is released, such that a tail hook 712 on the locking button 71 and the locking button latch hook 82 on the upper cover 2 are hooked to each other, and the trigger 6 cannot be reset. Thus, the switch achieves the closing and locking function.

As shown in FIGS. 3-7, the electrical connection structure 9 includes a movable contact terminal assembly 91, a stationary contact piece assembly 92 cooperating with the movable contact terminal assembly 91, a movable contact terminal bracket 93 for fixing the movable contact terminal assembly 91 and a contact spring group 94 for electrically connecting the movable contact terminal bracket 93 to the circuit board assembly 5. The stationary contact piece assembly 92, the movable contact terminal bracket 93 and the contact spring group 94 are mounted on the base body 1. The electrical connection structure 9 further includes a connection sheet 95 and an output sheet 96 that are arranged on the base body 1. The connection sheet 95 is provided with a connection sheet connection column 951, such that the connection sheet 95 is electrically connected with the circuit board assembly 5 through the connection sheet connection column 951. In addition, the output sheet 96 is provided with an output sheet connection column 961, such that the output sheet 96 is electrically connected with the circuit board assembly 5 through the output sheet connection column 961.

As shown in FIGS. 5-7, the movable contact terminal assembly 91 includes a rotating block 911, a driving spring plate 912, a movable contact terminal 913 and a movable contact point 914. A push shaft groove 31 is formed in one end of the push shaft 3 arranged in the box body, and a rotating block connection head 9111 is arranged at one end of the rotating block 911, such that the one end of the rotating block 911 is connected with the push shaft 3 through cooperation between the rotating block connection head 9111 and the push shaft groove 31. A rotating block hook 9112 is arranged at the other end of the rotating block 911, and a first clamping slot 9121 for spring plate is formed in one end of the driving spring plate 912, such that the one end of the driving spring plate 912 is connected with the rotating block 911 through cooperation between the rotating block hook 9112 and the first clamping slot 9121 for spring plate. A second clamping slot 9122 for spring plate is formed in the other end of the driving spring plate 912, and a movable contact terminal connection head 9131 is arranged at one end of the movable contact terminal 913, such that the other end of the driving spring plate 912 is connected with the movable contact terminal 913 through cooperation between the second clamping slot 9122 for spring plate and the movable contact terminal connection head 9131. A movable contact terminal connection block 9132 is arranged at the other end of the movable contact terminal 913, and a movable contact terminal connection slot 9133 is formed in the movable contact terminal connection block 9132; and in addition, the movable contact terminal bracket 93 is provided with a bracket connection head 931, and a bracket connection hole 932 is formed in the bracket connection head 931, such that the movable contact terminal connection block 9132 is connected with a bottom of the rotating block 911 through the movable contact terminal connection slot 9133 after passing through the bracket connection hole 932. The movable contact point 914 is arranged at a bottom of one end, connected with the driving spring plate 912, of the movable contact terminal 913.

In this embodiment, after the trigger 6 is pressed, the trigger 6 can drive the push shaft 3 to move downwards, and the push shaft 3 drives a tail of the rotating block 911, thus driving the rotating block 911 to perform clockwise rocking motion. A right side of the driving spring plate 912 tilts upwards. When the driving spring plate 912 reaches a height, a left side of the driving spring plate 912 can instantly press a head of the moving contact terminal 913, such that the moving contact point 914 is in contact with the stationary contact point 924, thereby achieving an instant electrical connection function of the switch.

As shown in FIG. 5, the stationary contact piece assembly 92 includes a first binding post 921 a second binding post 922, a stationary contact piece 923 and a stationary contact point 924. The first binding post 921 is connected with the connection sheet 95. The second binding post 922 is connected with the stationary contact piece 923. The stationary contact point 924 is arranged on the stationary contact piece 923, such that the stationary contact point 924 cooperates with the movable contact point 914.

As shown in FIG. 5, the stationary contact piece assembly 92 is configured to further include a screw fixing plate 925. By using the screw fixing plate 925, the first binding post 921 and the second binding post 922 are fixed on the base body 1.

As shown in FIG. 5, the movable contact terminal assembly 91 further includes an auxiliary spring plate 915. The auxiliary spring plate 915 is provided with a spring plate mounting hole group 9151. In addition, the movable contact terminal bracket 93 is provided with a bracket mounting hole group 933, such that a second fastener 11 sequentially passes through the bracket mounting hole group 933 and the spring plate mounting hole group 9151 to connect the auxiliary spring plate 915 with the movable contact terminal bracket 93. It should be noted that the second fastener 11 may be a screw.

As shown in FIGS. 5, 8 and 9, the base body 1 is provided with a base body mounting slot group 101, such that both the first binding post 921 and the second binding post 922 are arranged in the base body mounting slot group 101. Binding post mounting heads 926 are respectively arranged at the top of the first binding post 921 and the top the second binding post 922, and wiring holes 927 are respectively formed in the connection sheet 95 and the stationary contact piece 923, such that the connection sheet 95 and the stationary contact piece 923 are respectively connected with the first binding post 921 and the second binding post 922 through cooperation between the binding post mounting heads 926 and the wiring holes 927.

As shown in FIGS. 1-2 and 5, a stepped sealing sleeve 12 is arranged on a portion, extending out from the box body, of the push shaft 3, and in addition, an upper cover mounting platform 201 is arranged at a top of the upper cover 2, such that the stepped sealing sleeve 12 is connected with the upper cover mounting platform 201 to achieve a dustproof function of the push shaft portion. A first peripheral groove 102 for base body and a second peripheral groove 103 for base body are formed in the base body 1, and in addition, the upper cover 2 is provided with a first peripheral protruding bar for upper cover and a second peripheral protruding bar for upper cover, such that the first peripheral groove 102 for base body and the first peripheral protruding bar for upper cover form a first labyrinth interlocking structure, and the second peripheral groove 103 for base body and the second peripheral protruding bar for upper cover form a second labyrinth interlocking structure to achieve a dustproof function between the base body and the upper cover.

As shown in FIG. 5, an upper cover connection post 202 is arranged at a top of the upper cover 2, and a trigger connection post is arranged at a bottom of the trigger 6, such that one end of the reset spring 4 is connected with the upper cover connection post 202, and another end of the reset spring 4 is connected with the trigger connection post.

It should be noted that as shown in FIG. 5, in this embodiment, a trigger fixing hole 62 is formed in one end of the trigger that is not provided with a locking structure, and a corresponding upper cover fixing platform 203 is arranged on the upper cover. Fixing posts 204 are arranged on two sides of the upper cover fixing platform 203. The trigger 7 is movably connected with the upper cover 2 through the trigger fixing hole 73 on the trigger 7 and the fixed posts 204 on the upper cover fixing platform 203.

It should be further noted that as shown in FIG. 5, in this embodiment, a push shaft through hole 32 is formed in one end, extending out from the box body, of the push shaft, and a trigger clamping slot is formed in the trigger 6. A pin 13 is clamped onto the trigger clamping slot after passing through the push shaft through hole to connect the push shaft to the trigger 6.

A working process of the switch with the restart protection function for the trigger provided in this embodiment of the present disclosure is as follows.

The trigger 6 is pressed. The trigger 6 drives the push shaft 3 to move downwards, and the push shaft 3 drives the tail of the rotating block 911, thus driving the rotating block 911 to perform clockwise rocking motion. The right side of the driving spring plate 912 tilts upwards. When the driving spring plate 912 reaches a height, the left side of the driving spring plate 912 can instantly press the head of the moving contact terminal 913, such that the moving contact point 914 is in contact with the stationary contact point 924, thereby achieving the instant electrical connection function of the switch.

After the switch is electrically connected, the locking button 71 is then pulled, and the trigger 6 is released. The tail hook 712 on the locking button 71 and the locking button latch hook 82 on the upper cover 2 are hooked to each other, and the trigger 6 cannot be reset. Thus, the switch achieves the closing and locking function.

The trigger 6 is pressed again. The locking button 71 is reset under the action of the locking button spring 72. In this case, the trigger 6 is released and moves upwards under the action of the reset spring 4, thus driving the push shaft 3 to move upwards. The push shaft 3 drives the tail of the rotating block 911, thus driving the rotating block 911 to perform counterclockwise rocking motion. The right side of the driving spring plate 912 tilts downwards. When the driving spring plate 912 reaches a height, the left side of the driving spring plate 912 can instantly pull up the head of the moving contact terminal 913, such that the moving contact point 914 is instantly separated from the stationary contact point 924, thereby achieving the instant disconnection function of the switch.

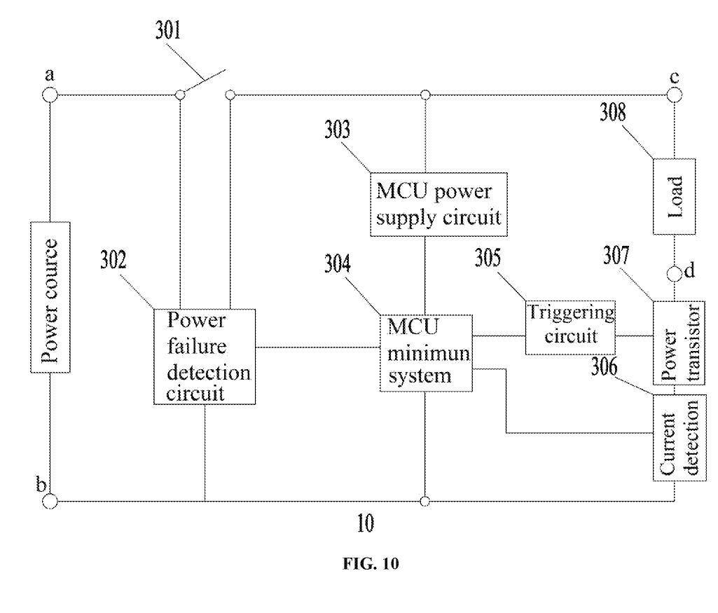

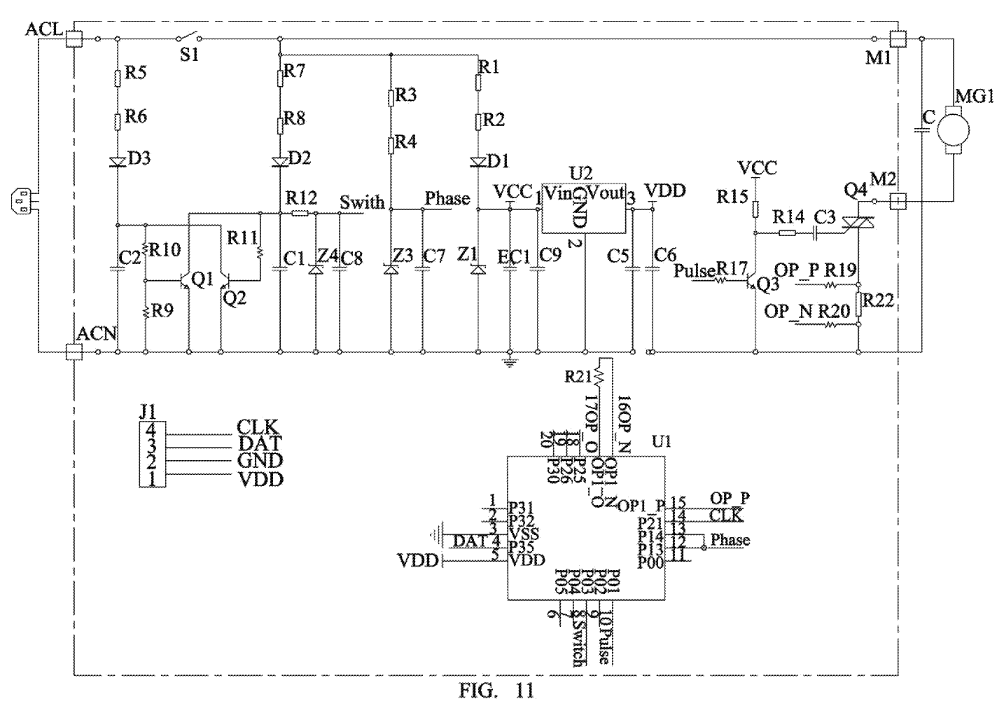

FIG. 10 is a schematic circuit diagram of the switch with the restart protection function for the trigger according to the present disclosure. As shown in FIG. 10, the circuit structure includes a first input end a, a second input end b, a first output end c, and a second output end d. The first input end a and the second input end b are respectively connected with two poles of a power source, and the first output end c and the second output end d are connected with two ends of a load 908.

The circuit further includes a switch 301, a power failure detection circuit 302, an MCU power supply circuit 303, an MCU minimum system 304, a triggering circuit 305, a current detection circuit 306 and a power transistor 307.

An input end of the switch 301 is connected with the first input end a and the second input end b, and an output end of the switch 301 is connected with the first output end c and a first port of the current detection circuit 306.

Four input ports of the power failure detection circuit 302 are connected with four ports of the switch 301, and an output port of the power failure detection circuit 302 is connected with a first input port of the MCU minimum system 304.

A first port and a second port of the MCU power supply circuit 303 are connected with the output end of the switch 301, and an output port of the MCU power supply circuit 303 is connected with a power input end of the MCU minimum system 304.

An input end of the triggering circuit 305 is connected with a second port of the MCU minimum system 304, and an output end of the triggering circuit 305 is connected with a control port of the power transistor 307.

A first port of the current detection circuit 306 is connected with a second port of the power transistor 307. A second port of the current detection circuit 306 is connected with the output end of the switch 301. An output port of the current detection circuit 306 is connected with a third port of the MCU minimum system 304.

An input end of the power transistor 307 is connected with the second output end d. An output end of the power transistor 307 is connected with an input port of the current detection circuit 306. A control port of the power transistor 307 is connected with an output port of the triggering circuit 305.

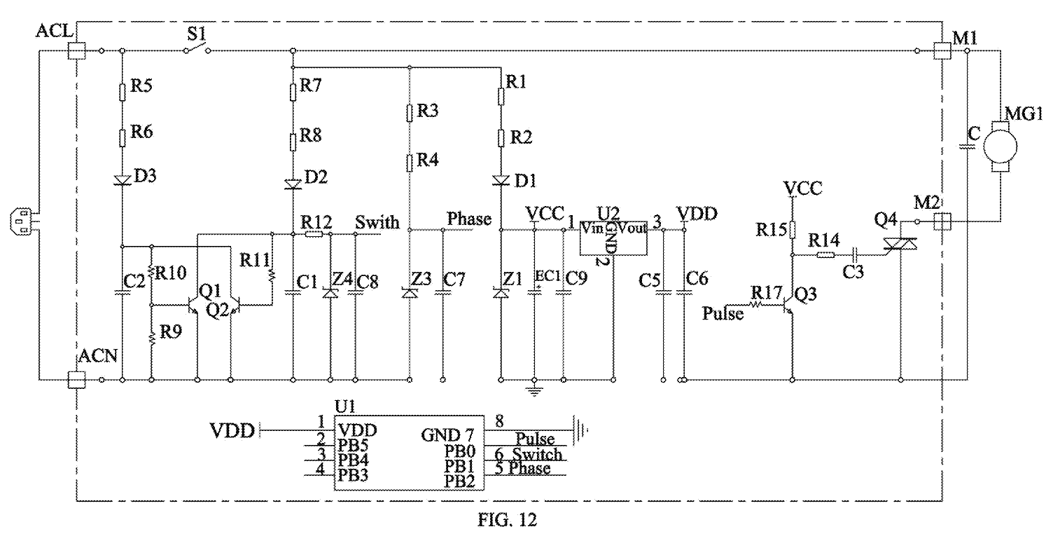

FIGS. 11 and 12 are electronic circuit diagrams of a circuit board of the switch with the restart protection function according to the present disclosure.

Finally, it should be noted that the above embodiments are only configured to explain the technical solutions of the present disclosure and not intended to limit the scope of protection of the present disclosure. Although the present disclosure has been described in detail with reference to the preferred embodiments, those of ordinary skill in the art should understand that the technical solutions of the present disclosure can be modified or equivalently replaced without departing from the spirit and scope of the technical solutions of the present disclosure.

What is claimed is:

1. A switch with a restart protection function for a trigger, wherein the switch comprises a base body, an upper cover, a push shaft, a reset spring and a circuit board assembly; one end of the push shaft extends out of a box body composed of the base body and the upper cover; the trigger is arranged at the one end of the push shaft extending out of the box body;
a locking structure is arranged on the trigger; a locking block structure cooperating with the locking structure is arranged on the upper cover; and an electrical connection structure cooperating with the circuit board assembly is arranged in the box body.

2. The switch according to claim 1, wherein the locking structure comprises a locking button and a locking button spring; a mounting cavity is formed in the locking button, mounting posts are respectively arranged at a bottom and a top of the mounting cavity; the locking button spring is mounted within the mounting cavity through the mounting posts;
a mounting hole is formed in the trigger; first through holes are respectively formed in two side walls of the mounting hole; second through holes are respectively formed in two side walls of the mounting cavity; a first fastener passes through the first through holes and the second through holes to movably connect the locking button with the trigger;
the locking block structure comprises a locking button pressing block and a locking button latch hook; and both the locking button pressing block and the locking button latch hook cooperate with the locking button.

3. The switch according to claim 1, wherein the electrical connection structure comprises a movable contact terminal assembly, a stationary contact piece assembly cooperating with the movable contact terminal assembly, a movable contact terminal bracket for fixing the movable contact terminal assembly and a contact spring group for electrically connecting the movable contact terminal bracket with the circuit board assembly; the stationary contact piece assembly, the movable contact terminal bracket and the contact spring group are mounted on the base body;
the electrical connection structure further comprises a connection sheet and an output sheet that are arranged on the base body;
the connection sheet is provided with a connection sheet connection column; the connection sheet is electrically connected with the circuit board assembly through the connection sheet connection column; the output sheet is provided with an output sheet connection column; and the output sheet is electrically connected with the circuit board assembly through the output sheet connection column.

4. The switch according to claim 3, wherein the movable contact terminal assembly comprises a rotating block, a driving spring plate, a movable contact terminal and a movable contact point;
a push shaft groove is formed in one end of the push shaft arranged in the box body; a rotating block connection head is arranged at one end of the rotating block; the one end of the rotating block is connected with the push shaft through cooperation between the rotating block connection head and the push shaft groove;
a rotating block hook is arranged at another end of the rotating block; a first clamping slot for spring plate is formed in one end of the driving spring plate; the one end of the driving spring plate is connected with the rotating block through cooperation between the rotating block hook and the first clamping slot for spring plate;
a second clamping slot for spring plate is formed in another end of the driving spring plate; a movable contact terminal connection head is arranged at one end of the movable contact terminal; the other end of the driving spring plate is connected with the movable contact terminal through cooperation between the second clamping slot for spring plate and the movable contact terminal connection head;
a movable contact terminal connection block is arranged at another end of the movable contact terminal; a movable contact terminal connection slot is formed in the movable contact terminal connection block; the movable contact terminal bracket is provided with a bracket connection head; a bracket connection hole is formed in the bracket connection head; the movable contact terminal connection block is connected with a bottom of the rotating block through the movable contact terminal connection slot after passing through the bracket connection hole; and
the movable contact point is arranged at a bottom of one end, connected with the driving spring plate, of the movable contact terminal.

5. The switch according to claim 4, wherein the stationary contact piece assembly comprises a first binding post, a second binding post, a stationary contact piece and a stationary contact point; the first binding post is connected with the connection sheet; the second binding post is connected with the stationary contact piece; and the stationary contact point is arranged on the stationary contact piece and cooperates with the movable contact point.

6. The switch according to claim 5, wherein the stationary contact piece assembly further comprises a screw fixing plate; and both the first binding post and the second binding post are fixed to the base body through the screw fixing plate.

7. The switch according to claim 5, wherein the movable contact terminal assembly further comprises an auxiliary spring plate; the auxiliary spring plate is provided with a spring plate mounting hole group; the movable contact terminal bracket is provided with a bracket mounting hole group; and a second fastener sequentially passes through the bracket mounting hole group and the spring plate mounting hole group to connect the auxiliary spring plate with the movable contact terminal bracket.

8. The switch according to claim 6, wherein the base body is provided with a base body mounting slot group; the first binding post and the second binding post are arranged within the base body mounting slot group;
binding post mounting heads are respectively arranged at tops of both the first binding post and the second binding post; wiring holes are respectively formed in the connection sheet and the stationary contact piece; and the connection sheet and the stationary contact piece are respectively connected with the first binding post and the second binding post through cooperation between the binding post mounting heads and the wiring holes.

9. The switch according to claim 1, wherein a stepped sealing sleeve is arranged on a portion, extending out from the box body, of the push shaft; an upper cover mounting platform is arranged at a top of the upper cover; the stepped sealing sleeve is connected with the upper cover mounting platform;
a first peripheral groove for base body and a second peripheral groove for base body are formed in the base body; the upper cover is provided with a first peripheral protruding bar for upper cover and a second peripheral protruding bar for upper cover; the first peripheral groove for base body and the first peripheral protruding bar for upper cover form a first labyrinth interlocking structure; and the second peripheral groove for base body and the second peripheral protruding bar for upper cover form a second labyrinth interlocking structure.

10. The switch according to claim 1, wherein an upper cover connection post is arranged at a top of the upper cover; a trigger connection post is arranged at a bottom of the trigger; one end of the reset spring is connected with the upper cover connection post; and another end of the reset spring is connected with the trigger connection post.

11. The switch according to claim 2, wherein the electrical connection structure comprises a movable contact terminal assembly, a stationary contact piece assembly cooperating with the movable contact terminal assembly, a movable contact terminal bracket for fixing the movable contact terminal assembly and a contact spring group for electrically connecting the movable contact terminal bracket with the circuit board assembly; the stationary contact piece assembly, the movable contact terminal bracket and the contact spring group are mounted on the base body;
the electrical connection structure further comprises a connection sheet and an output sheet that are arranged on the base body;
the connection sheet is provided with a connection sheet connection column; the connection sheet is electrically connected with the circuit board assembly through the connection sheet connection column; the output sheet is provided with an output sheet connection column; and the output sheet is electrically connected with the circuit board assembly through the output sheet connection column.

12. The switch according to claim 2, wherein a stepped sealing sleeve is arranged on a portion, extending out from the box body, of the push shaft; an upper cover mounting platform is arranged at a top of the upper cover; the stepped sealing sleeve is connected with the upper cover mounting platform;
a first peripheral groove for base body and a second peripheral groove for base body are formed in the base body; the upper cover is provided with a first peripheral protruding bar for upper cover and a second peripheral protruding bar for upper cover; the first peripheral groove for base body and the first peripheral protruding bar for upper cover form a first labyrinth interlocking structure; and the second peripheral groove for base body and the second peripheral protruding bar for upper cover form a second labyrinth interlocking structure.

13. The switch according to claim 2, wherein an upper cover connection post is arranged at a top of the upper cover; a trigger connection post is arranged at a bottom of the trigger; one end of the reset spring is connected with the upper cover connection post; and another end of the reset spring is connected with the trigger connection post.

14. The switch according to claim 11, wherein the movable contact terminal assembly comprises a rotating block, a driving spring plate, a movable contact terminal and a movable contact point;
a push shaft groove is formed in one end of the push shaft arranged in the box body; a rotating block connection head is arranged at one end of the rotating block;
the one end of the rotating block is connected with the push shaft through cooperation between the rotating block connection head and the push shaft groove;
a rotating block hook is arranged at another end of the rotating block; a first clamping slot for spring plate is formed in one end of the driving spring plate; the one end of the driving spring plate is connected with the rotating block through cooperation between the rotating block hook and the first clamping slot for spring plate;
a second clamping slot for spring plate is formed in another end of the driving spring plate; a movable contact terminal connection head is arranged at one end of the movable contact terminal; the other end of the driving spring plate is connected with the movable contact terminal through cooperation between the second clamping slot for spring plate and the movable contact terminal connection head;
a movable contact terminal connection block is arranged at another end of the movable contact terminal; a movable contact terminal connection slot is formed in the movable contact terminal connection block; the movable contact terminal bracket is provided with a bracket connection head; a bracket connection hole is formed in the bracket connection head; the movable contact terminal connection block is connected with a bottom of the rotating block through the movable contact terminal connection slot after passing through the bracket connection hole; and
the movable contact point is arranged at a bottom of one end, connected with the driving spring plate, of the movable contact terminal.

15. The switch according to claim 14, wherein the stationary contact piece assembly comprises a first binding post, a second binding post, a stationary contact piece and a stationary contact point; the first binding post is connected with the connection sheet; the second binding post is connected with the stationary contact piece; and the stationary contact point is arranged on the stationary contact piece and cooperates with the movable contact point.

16. The switch according to claim 15, wherein the stationary contact piece assembly further comprises a screw fixing plate; and both the first binding post and the second binding post are fixed to the base body through the screw fixing plate.

17. The switch according to claim 15, wherein the movable contact terminal assembly further comprises an auxiliary spring plate; the auxiliary spring plate is provided with a spring plate mounting hole group; the movable contact terminal bracket is provided with a bracket mounting hole group; and a second fastener sequentially passes through the bracket mounting hole group and the spring plate mounting hole group to connect the auxiliary spring plate with the movable contact terminal bracket.

18. The switch according to claim 16, wherein the base body is provided with a base body mounting slot group; the first binding post and the second binding post are arranged within the base body mounting slot group;
binding post mounting heads are respectively arranged at tops of both the first binding post and the second binding post; wiring holes are respectively formed in the connection sheet and the stationary contact piece; and the connection sheet and the stationary contact piece are respectively connected with the first binding post and the second binding post through cooperation between the binding post mounting heads and the wiring holes.
